(19) United States
(12) Patent Application Publication
(10) Pub. No.: US 2025/0138342 A1
(43) Pub. Date: May 1, 2025

(54) METHOD FOR INTEGRATING ELECTRONICS INTO SPECTACLE FRAME

(71) Applicant: Pixieray Oy, Espoo (FI)

(72) Inventors: Tapio Selby, Espoo (FI); Otto Huittinen, Vantaa (FI)

(73) Assignee: Pixieray Oy, Espoo (FI)

(21) Appl. No.: 18/494,337

(22) Filed: Oct. 25, 2023

(51) Int. Cl. G02C 11/00

(52) U.S. Cl. CPC G02C 11/10

(57) ABSTRACT

A spectacle frame having electronic components integrated therein, includes: an insert having a base structure, the base structure being employed to accommodate the electronic components; the electronic components assembled onto the base structure of the at least one insert; and a plastic resin encapsulating the electronic components at least partially, wherein the plastic resin is affixed to the at least one insert, wherein the at least one insert and at least a part of the assembled electronic components are securely embedded within the plastic resin.

### TECHNICAL FIELD

The present disclosure relates to spectacle frames having electronic components integrated therein. Moreover, the present disclosure relates to methods for manufacturing spectacle frames having electronic components integrated therein.

### BACKGROUND

Traditional eyewear provides vision correction or protection from ultraviolet light, wherein the traditional eyewear could be a prescription glasses or sunglasses. In the recent decade, smart eyewear is used to sense the ultraviolet light, track health indicators, capturing images, enable hands-free phone conversations, enhance hearing, and augmented reality.

Despite recent advancements in technology related to the smart eyewear, existing techniques and equipment have several limitations associated herewith. Typically, conventional smart eyewear use a manual assembly of electronic components to the smart eyewear. Such electrical components are covered with a plastic material with an attachment means, such as, snaps, screws, and similar. The electronic components incorporate smart features in the smart eyewear. However, such plastic material does not provide structural integrity to the conventional smart eyewear, and the electronic components could be electrically disconnected due to the manual assembly of the electronic components.

Therefore, in light of the foregoing discussion, there exists a need to overcome the aforementioned drawbacks.

### SUMMARY

The aim of the present disclosure is to provide spectacle frames having electronic components integrated therein, and methods for manufacturing spectacle frames having electronic components integrated therein to facilitate securely electrically connecting the electronic components within the spectacle frame which provides protection to the electronic components. The aim of the present disclosure is achieved by spectacle frames having electronic components integrated therein, and methods for manufacturing spectacle frames having electronic components integrated therein as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates an architecture of a spectacle frame having electronic components integrated therein, in accordance with an embodiment of the present disclosure; and

FIG. 2 shows a flowchart illustrating steps of a method for manufacturing a spectacle frame having electronic components integrated therein, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a spectacle frame having electronic components integrated therein, comprising:
at least one insert having a base structure, the base structure being employed to accommodate the electronic components;
the electronic components assembled onto the base structure of the at least one insert; and
a plastic resin encapsulating the electronic components at least partially, wherein the plastic resin is affixed to the at least one insert,
wherein the at least one insert and at least a part of the assembled electronic components are securely embedded within the plastic resin.

The aforementioned spectacle frame has electronic components integrated therein, which enables the spectacle frame to incorporate smart features due to the presence and usage of the electronic components. Examples of such smart features are augmented reality, health monitoring, gesture control, eye tracking and connectivity. This is provided by assembling the electronic components onto the base structure of the at least one insert, wherein the base structure has enough space to accommodate the electronic components. The plastic resin encompasses the electronic components at least partially to provide protection to the electronic components, while simultaneously maintaining a structural integrity of the spectacle frame. A synergistic effect of the aforementioned features is that together, the at least one insert, the plastic resin, and the electronic components embedded onto the base structure of the at least one insert creates a robust and a resilient spectacle frame, wherein the plastic resin protects the electronic components from environmental factors, such as, moisture, chemicals, temperature fluctuations, physical impact, and the like.

In a second aspect, the present disclosure provides a spectacle frame having electronic components integrated therein, comprising:
a printed circuit board (PCB) onto which the electronic components are assembled; and
a plastic resin encapsulating the electronic components at least partially, wherein the plastic resin is affixed to the PCB,
wherein the PCB and at least a part of the electronic components are securely embedded within the plastic resin.

The aforementioned spectacle frame has electronic components integrated therein, which enables the spectacle frame to incorporate smart features due to the presence and usage of the electronic components assembled on the PCB. The PCB provides a rigid platform for mounting and connecting the electronic components. The PCB ensures that the electrical components remain securely in place and maintain electrical connections when the plastic resin encapsulates the electronic components. When the electronic components are securely embedded within the plastic resin, the plastic resin provides protection against physical impact, moisture, dust, and similar. A synergistic effect of the aforementioned features is that together, the PCB, the plastic resin, and the electronic components embedded onto the PCB create a robust and a durable spectacle frame. Consequently, leading to more compact and streamlined design.

In a third aspect, the present disclosure provides a method for manufacturing a spectacle frame having electronic components integrated therein, comprising:
assembling the electronic components onto a base structure of an at least one insert;
placing the at least one insert with the assembled electronic components into a mould;
injecting a plastic resin into the mould, thereby encapsulating the electronic components at least partially and affixing the plastic resin to the at least one insert; and
curing the plastic resin, wherein the at least one insert and at least a part of the assembled electronic components are securely embedded within the plastic resin.

The aforementioned method is for manufacturing the spectacle frame having electronic components integrated therein, which facilitates designing the spectacle frame as per requirements. The mould ensures that the spectacle frame is manufactured with a particular dimension and feature, thereby ensuring uniform quality. Furthermore, injecting the plastic resin into the mould minimises wastage of the plastic resin because it only uses a particular amount of the plastic resin to fill the mould. The synergistic effect arises from a combined benefit of integrating the electronic components onto the base structure of the at least one insert, encapsulating the electronic components in the plastic resin, and creating the spectacle frame that is robust, durable and compact.

Throughout the present disclosure, the term “spectacle frame” refers to a structural component that is employed to hold at least one optical element (for example, such as at least one eye lens) of an optical apparatus. Herein, the optical apparatus is to be worn over eyes of the user. In this regard, the spectacle frame is designed in a manner that the at least one optical element is firmly arranged on the spectacle frame. In an example, when the optical apparatus is implemented as a pair of eyeglasses, the spectacle frame may hold two optical elements, wherein a first optical element is employed for a first eye of a user, and a second optical element is employed for a second eye of the user. It will be appreciated that a material of the spectacle frame could be plastic, metal, polymer, and the like. Moreover, the spectacle frame may be lightweight, ergonomically designed, and easy to use. Examples of the optical apparatuses include, but are not limited to, a pair of glasses, a pair of sunglasses, smart glasses, and a head-mounted display.

Throughout the present disclosure, the term “insert” refers to a spectacle frame component that enables to hold and secure the electronic components. On one side, the at least one insert has a base structure, and on an opposite side, the at least one insert may have a flat surface. The term “base structure” refers to the insert part that includes features (such as depressions, protrusions, holes, etc.) to accommodate electronic components and allow for holding the at least one insert in place during moulding. The at least one insert and the base structure can be made of any one of: a plastic material, a polymer resin, a rubber material, a silicone material.

In some implementations, the spectacle frame further comprises at least one additional insert. The at least one additional insert could be employed to provide mechanical support to the spectacle frame. In such a case, the at least one additional insert is not employed to accommodate any electronic component.

The electronic components are attached or integrated onto the base structure of the at least one insert. In this regard, the electronic components are securely arranged on the base structure and connected within the at least one insert. This ensures that the electrical components are integrated, protected, and function as intended, within the spectacle frame.

Optionally, the electronic components comprise at least one of: a processor, a digital signal processor, at least one light detector, at least one light emitter, at least one sensor, at least one microphone, at least one power supply, at least one transducer that is to be employed to generate vibrations. It will be appreciated that the processor is communicably coupled to the digital signal processor, the at least one light detector, the at least one light emitter, the at least one sensor, the at least one microphone, the at least one power supply, and the at least one transducer. The processor could be implemented as any one of: a microprocessor, a microcontroller, or a controller. As an example, the processor could be implemented as an application-specific integrated circuit (ASIC) chip or a reduced instruction set computer (RISC) chip. Moreover, the term “digital signal processor” refers to a specialized processor which is configured to perform operations on digital signals, wherein the operations could be mathematical in nature. Such digital signal processors are well-known in the art. The term “light detector” refers to a device that is used to detect and/or measure light incident thereupon. Examples of the light detectors may include, but are not limited to, infrared transceivers, radio frequency identification devices, visible light camera, and infrared camera. The term “light emitter” refers to an element that produces or emits light beams when activated, emits light. Examples of the light emitters may include, but are not limited to, light emitting diodes (LEDs), laser diodes, infrared emitters, and ultraviolet emitters. The term “sensor” refers to a device which detects and/or measures data from a real-world environment, and converts the data into electrical or digital signals to be processed by the at least one processor. Examples of the at least one sensor may include, but are not limited to, a temperature sensor, a pressure sensor, a light sensor, and a proximity sensor. The term “microphone” refers to a device that captures acoustic energy and converts the acoustic energy into electrical signals (namely, a voltage signal and/or a current signal) to be processed by the at least one processor. The term “power supply” refers to an electrical device that provides electrical power to operate the spectacle frame when in use. Such power supplies are well-known in the art. The at least one transducer utilizes piezoelectric effect to generate vibrations when voltage is applied to said at least one transducer. The vibrations are generated to deliver information via haptic feedback, to the user.

A technical effect of the electrical components is that integrating said electrical components in the spectacle frame facilitates incorporation of the smart features in the spectacle frame. Additionally, the electrical components are incorporated in an accurate and protective manner.

In an embodiment, the electronic components are assembled onto the base structure of the at least one insert using a printed circuit board (PCB). Herein, the term “printed circuit board” provides a platform for mechanically supporting and electrically connecting the electrical components. The PCB-s are well-known in the art. The PCB could be implemented as: a flexible PCB, a partially flexible PCB, or a rigid PCB. When the PCB is implemented as the flexible PCB or the partially flexible PCB, a material for construction is able to withstand bending and folding. The assembly can be done by assembling the electronic components on the PCB and then assembling the PCB on the base structure of the at least one insert. One example of such a material is polyimide. When the PCB is implemented as the rigid PCB, a material for construction provides a solid and a stable platform for assembling the electronic components. One example of such a material is epoxy-based laminate. A technical effect of assembling the electronic components onto the base structure of the at least one insert using the PCB is to arrange the electronic components in a compact manner, thus facilitating comfort when wearing the spectacle frame.

Optionally, the PCB is mounted on the base structure of the at least one insert. In this regard, the PCB is arranged on a particular location on the base structure. This particular location aligns with an attachment point (for example, such as a hole, a slot) of the PCB. The PCB is mounted in such a manner that a base of the PCB lies on top of the base structure of the at least one insert, with the electronic components facing a required direction. Moreover, after mounting the PCB on the base structure of the at least one insert, the PCB can be attached using an attachment technique. Examples of such attachment techniques may include, but are not limited to, soldering, using attachment means (for example, a screw, a fastener, a clip, a retainer), and using an adhesive. Such attachment techniques are well-known in the art. A technical effect of mounting the PCB on the base structure of the at least one insert is that the base structure provides mechanical support when the PCB is implemented as the flexible PCB or the partially-flexible PCB, and is electrically connected directly into the spectacle frame.

In another embodiment, the electronic components are assembled onto the base structure of the at least one insert using direct contacts and wiring that are applied onto the base structure of the at least one insert. In this regard, the direct contacts and the wiring are attached on the base structure of the at least one insert to provide electrical connections to the electrical components. Such electrical connections are provided when terminals of the electrical components are directly in contact with the direct contacts and the wiring of the base structure of the at least one insert. A technical effect of assembling the electronic components onto the base structure of the at least one insert using direct contacts and the wiring is that this can be used to create spectacle frames for specialized applications (for example, such as, visual acuity testing, eye condition testing, augmented reality).

Optionally, the direct contacts and the wiring are applied onto the base structure of the at least one insert using at least one of: a moulded interconnect device (MID), laser direct structuring (LDS), printed electronics, two-shot moulding. A technical effect is that this enables precise integration of the wiring and conductive traces directly onto the base structure, thereby reducing a requirement for additional components or external wiring. Herein, the MID is designed to integrate electrical and mechanical functions into a three-dimensional moulded structure which is created using injection moulding. Thus, the electronic components are embedded on to the base structure of the at least one insert. The LDS uses a laser to create conductive traces of the schematic of the electric circuit onto the base structure of the at least one insert, thereby creating a physical chemical reaction. Due to the physical-chemical reaction, a portion of the base structure is altered, while simultaneously selectively activating the portion of the base structure. This selective activation of the portion of the base structure initiates a metallization process which is used to create the conductive traces. The printed electronics employs a printing technology to electrically connect the electronic components with the at least one insert. The printing technology uses any one of: organic conducting materials, semiconducting materials, printable inorganic materials. The two-shot moulding combines two different materials, which are injected into a mould to create a single integrated part with distinct sections or features made from each of the two different materials. In this regard, the two different materials could be a non-metallic material and a metallic material, wherein the non-metallic material provides insulation, and the metallic material provides electrical connectivity between the electrical components.

Optionally, the electronic components are assembled onto the base structure of the at least one insert by gluing the electronic components onto the direct contacts using a conductive glue. Herein, the term “conductive glue” refers to a material having adhesive properties as well as electrical conductivity properties. The conductive glue is using to bond the electrical components onto the direct contacts of the base structure of the at least one insert, whilst providing an electrical connection between the electrical components and the direct contacts. Examples of the conductive glue may include, but are not limited to, an electrically-conductive epoxy adhesive, an electrically-conductive silicone adhesive, an electrically-conductive acrylic adhesive, and an electrically-conductive polyurethane adhesive. A technical effect of gluing the electronic components onto the direct contacts using a conductive glue is that the conductive glue can be applied in small quantities with precision, which enables the electronic components to be placed in close proximity to each other.

Throughout the present disclosure, the term “plastic resin” refers to a synthetic organic material or a semi-synthetic organic material that is durable and mouldable. In this regard, the plastic resin is injected into a mould in which the at least one insert is placed with the assembled electronic components. Herein, the mould comprises cavities corresponding to a shape of the spectacle frame. The plastic resin encapsulates the electronic components, and the plastic resin is also affixed to the at least one insert, on whose base structure the electronic components are assembled. When the electronic components comprise the processor, the plastic resin fully encapsulates the processor. When the electronic components comprise the at least one light detector, and optionally, the at least one light emitter, the plastic resin only partially encapsulates the at least one light detector and the at least one light emitter. The at least one insert and at least the part of the assembled electronic components are securely embedded within the plastic resin to form a cohesive spectacle frame with integrated electronic components. Examples of the plastic resin may include, but are not limited to, Acrylonitrile Butadiene Styrene (ABS), Low-Density Polyethylene (LDPE), High-Density Polyethylene (HDPE), polyamide, and polypropylene.

Optionally, the base structure has geometrical depressions for at least one of: accommodating the electronic components, holding the at least one insert in place during a process of encapsulation within the plastic resin. The geometrical depressions are concave when compared to a surrounding surface of the base structure. The geometrical depressions are shaped and positioned in a manner to accommodate the electronic components. Furthermore, the geometrical depressions could have features (for example, such as a size, a shape) that aligns with features of the electronic components which is to be accommodated on to the base structure of the at least one insert. When the geometrical depressions are used for holding the at least one insert in place, a risk of misalignment or movement is reduced. This beneficially ensures that the electronic components are encapsulated accurately and securely. A technical effect of the base structure having geometrical depressions is that the geometrical depressions can be used to securely attach the electronic components within the base structure, and to hold the at least one insert in a stable manner. Examples of the shapes of the geometrical depressions may include, but are not limited to, circular depressions, rectangular depressions, square depressions, and triangular depressions.

Optionally, the base structure has geometrical protrusions for at least one of: orienting the electronic components, holding the at least one insert in place during a process of encapsulation within the plastic resin. The term “geometric protrusions” refers to raised features that extend outward or rise above when compared to the surface of the base structure. The geometrical protrusions are shaped and positioned to ensure that the electronic components are placed at a required orientation and alignment. In this regard, the geometrical protrusions are used to rotate the electrical components in a required angle when assembled on to the base structure of the at least one insert. Moreover, by aligning with particular features on the base structure of the at least one insert, the geometrical protrusions prevent the at least one insert from shifting or moving during the process of encapsulation. A technical effect of the base structure having geometrical protrusions is that the geometrical protrusions can be used for rotating the electrical components at a particular angle, while holding them securely, thereby ensuring optimal integration. Examples of the shapes of the geometrical protrusions may include, but are not limited to, circular protrusions, rectangular protrusions, square protrusions, and triangular protrusions.

The present disclosure also relates to the second aspect as described above. Various embodiments and variants disclosed above, with respect to the aforementioned first aspect, apply mutatis mutandis to the second aspect.

In this regard, the PCB is implemented as a rigid PCB. The PCB is designed to hold and secure the electronic components, and provide electronic connections to the electronic components. The PCB provides a stable platform to support the electronic components. The plastic resin is injected into a mould in which the PCB is placed with the assembled electronic components. The plastic resin encapsulates the electronic components, and the plastic resin is also affixed to the at least one insert. Herein, the PCB and at least the part of the electronic components are securely embedded within the plastic resin to form a cohesive spectacle frame with integrated electronic components.

The present disclosure also relates to the third aspect as described above. Various embodiments and variants disclosed above, with respect to the aforementioned first aspect, apply mutatis mutandis to the third aspect.

The mould (or, an injection moulding tool) comprises cavities corresponding to the shape of the spectacle frame. The plastic resin is injected into the mould using injection moulding, which is then cured to harden the plastic resin. The at least one insert is put in the mould. In this regard, the at least one insert has geometrical features (namely, the geometrical depressions and/or the geometrical protrusions) that hold the at least one insert in place when the mould is closed, and the plastic resin is injected into the cavities of the mould. Such injection moulding is performed using an injection machine, wherein the injection machine is any one of: a horizontal type, a vertical type. The injection machine of a particular type (namely, the horizontal type, the vertical type) is used to secure the at least one insert in place before the mould is closed.

Subsequently, the plastic resin is exposed to conditions conducive to curing, wherein the conditions involve time and temperature. During curing, the plastic resin hardens and attains a structural integrity, that securely embeds the at least one insert and at least the part of the assembled electronic components. This embedding ensures that the electronic components are firmly held in place within the plastic resin. Such curing is performed using curing techniques. Examples of the curing techniques may include, but are not limited to, chemical curing, thermal curing, and ultraviolet (UV) Curing. Such curing techniques are well-known in the art.

Optionally, the method comprises manufacturing the at least one insert using any one of: injection moulding, additive manufacturing, machining. A technical effect of manufacturing the at least one insert in such a manner is that a required shape of the at least one insert can be created using such processes, with precision and repeatability. In an embodiment, the term “injection moulding” refers to a forming process in which a mould is employed to manufacture the at least one insert. In this regard, during the process of manufacturing the at least one insert using the injection moulding which is well-known in the art.

In another embodiment, the term “additive manufacturing” refers to a process in which layers of a material to be used for manufacturing the at least one insert, is successively printed, until the at least one insert is completely printed. Hence, each layer may be observed as a thinly-sliced cross-section of the at least one insert. In this regard, a three-dimensional (3D) digital model is used to manufacture the at least one insert. Hence, the additive manufacturing is commonly known as 3D printing.

In yet another embodiment, the term “machining” refers to a subtractive manufacturing process in which a material to be used for manufacturing the at least one insert, is removed in a controllable manner from a workpiece to manufacture the at least one insert. In this regard, a machine tool is used to remove the material from the workpiece, in a form of chips or swarf. Examples of the machine tools may include, but are not limited to, a lathe machine, a milling machine, a drill press, and a Computer Numerical Control (CNC) machine.

Optionally, the method comprises manufacturing the base structure that has geometrical depressions for at least one of: accommodating the electronic components, holding the at least one insert in place during the steps of injecting and curing. In this regard, the geometric depressions are used to secure the electronic components in position, thereby preventing movement or displacement during encapsulation of the electronic components at least partially and affixing the plastic resin to the at least one insert. When the geometrical depressions are used for holding the at least one insert in place, a risk of misalignment or movement is reduced during the steps of injecting or curing. A technical effect of the base structure having geometrical depressions is that the geometrical depressions can be used to securely attach the electronic components within the base structure, and to hold the at least one insert in a stable manner, during the steps of injecting and curing.

Optionally, the method comprises manufacturing the base structure that has geometrical protrusions for at least one of: orienting the electronic components, holding the at least one insert in place during the steps of injecting and curing. In this regard, the geometric protrusions are used to rotate the electrical components in a required angle when assembled on to the base structure of the at least one insert. Moreover, by aligning with particular features on the base structure of the at least one insert, the geometrical protrusions prevent the at least one insert from shifting or moving during the steps of injecting and curing. A technical effect of the base structure having geometrical protrusions is that the geometrical protrusions can be used for rotating the electrical components at a particular angle, while holding them securely, during the steps of injecting and curing.

Optionally, step of assembling the electronic components comprises:
assembling the electronic components onto a printed circuit board (PCB); and
mounting the PCB on the base structure of the at least one insert.

Optionally, the method comprises manufacturing a spectacle frame having the electronic components comprise at least one of: a processor, a digital signal processor, at least one light detector, at least one light emitter, at least one sensor, at least one microphone, at least one power supply, at least one transducer that is to be employed to generate vibrations.

### DETAILED DESCRIPTION OF THE DRAWINGS

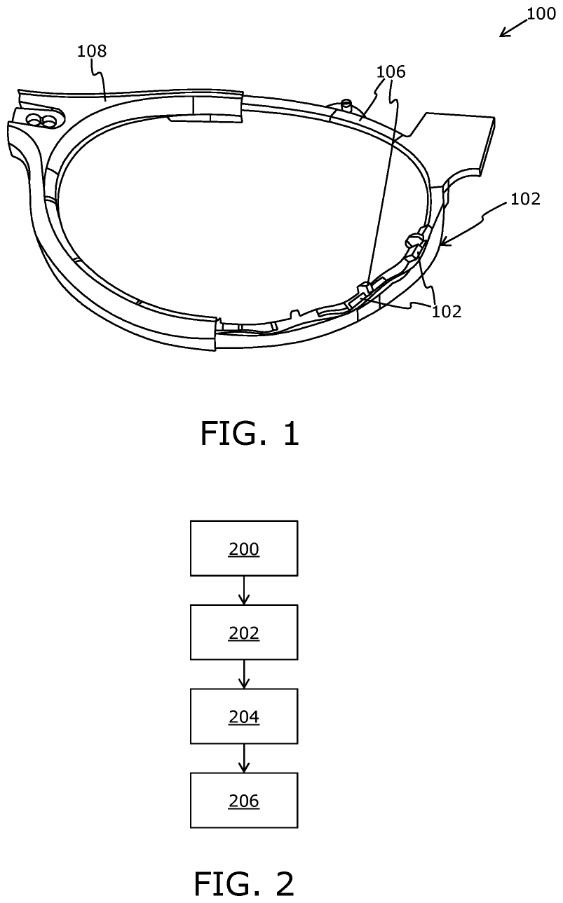

Referring to FIG. 1, there is illustrated an architecture of a spectacle frame 100 having electronic components 102 integrated therein, in accordance with an embodiment of the present disclosure. The spectacle frame 100 comprises an at least one insert (depicted as an insert 104) having a base structure 106, the electronic components 102 assembled onto the base structure 106 of the insert 104 and a plastic resin 108 encapsulating the electronic components 102 at least partially, wherein the plastic resin 108 is affixed to the insert 104. The base structure 106 of the insert 104 is employed to accommodate the electronic components 102. The insert 104 and at least a part of the assembled electronic components 102 are securely embedded within the plastic resin 106.

FIG. 1 is merely an example, which should not unduly limit the scope of the claims herein. A person skilled in the art will recognize many variations, alternatives, and modifications of embodiments of the present disclosure.

Referring to FIG. 2, there is shown a flowchart illustrating steps of a method for manufacturing a spectacle frame having electronic components integrated therein, in accordance with an embodiment of the present disclosure. At step 200, the electronic components are assembled onto a base structure of at least one insert. At step 202, the at least one insert is placed with the assembled electronic components into a mould. At step 204, a plastic resin is injected into the mould, thereby the electronic components are encapsulated at least partially and the plastic resin is affixed to the at least one insert. At step 206, the plastic resin is cured, wherein the at least one insert and at least a part of the assembled electronic components are securely embedded within the plastic resin.

The aforementioned steps are only illustrative and other alternatives can also be provided where one or more steps are added, one or more steps are removed, or one or more steps are provided in a different sequence without departing from the scope of the claims herein.

1. A spectacle frame having electronic components integrated therein, comprising:
at least one insert having a base structure, the base structure being employed to accommodate the electronic components;
the electronic components assembled onto the base structure of the at least one insert; and
a plastic resin encapsulating the electronic components at least partially, wherein the plastic resin is affixed to the at least one insert,
wherein the at least one insert and at least a part of the assembled electronic components are securely embedded within the plastic resin.

2. The spectacle frame of claim 1, wherein the base structure has geometrical depressions for at least one of: accommodating the electronic components, holding the at least one insert in place during a process of encapsulation within the plastic resin.

3. The spectacle frame of claim 1, wherein the base structure has geometrical protrusions for at least one of: orienting the electronic components, holding the at least one insert in place during a process of encapsulation within the plastic resin.

4. The spectacle frame of claim 1, wherein the electronic components are assembled onto the base structure of the at least one insert using a printed circuit board.

5. The spectacle frame of claim 1, wherein the electronic components are assembled onto the base structure of the at least one insert using direct contacts and wiring that are applied onto the at least one insert.

6. A spectacle frame having electronic components integrated therein, comprising:
a printed circuit board onto which the electronic components are assembled; and
a plastic resin encapsulating the electronic components at least partially, wherein the plastic resin is affixed to the PCB,
wherein the PCB and at least a part of the electronic components are securely embedded within the plastic resin.

7. The spectacle frame of claim 1, wherein the electronic components comprise at least one of: a processor, a digital signal processor, at least one light detector, at least one light emitter, at least one sensor, at least one microphone, at least one power supply, at least one transducer that is to be employed to generate vibrations.

8. A method for manufacturing a spectacle frame having electronic components integrated therein, comprising:
assembling the electronic components onto a base structure of at least one insert;
placing the at least one insert with the assembled electronic components into a mould;
injecting a plastic resin into the mould, thereby encapsulating the electronic components at least partially and affixing the plastic resin to the at least one insert; and
curing the plastic resin, wherein the at least one insert and at least a part of the assembled electronic components are securely embedded within the plastic resin.

9. The method of claim 8, further comprising manufacturing the at least one insert using any one of: injection moulding, additive manufacturing, machining.

10. The method of claim 8, wherein the base structure has geometrical depressions for at least one of: accommodating the electronic components, holding the at least one insert in place during the steps of injecting and curing.

11. The method of claim 8, wherein the base structure has geometrical protrusions for at least one of: orienting the electronic components, holding the at least one insert in place during the steps of injecting and curing.

12. The method of claim 8, wherein the step of assembling the electronic components comprises:
assembling the electronic components onto a printed circuit board; and
mounting the PCB on the base structure of the at least one insert.

13. The method of claim 8, wherein the step of assembling the electronic components comprises:
applying direct contacts and wiring onto the base structure of the at least one insert using at least one of: a moulded interconnect device, laser direct structuring, printed electronics, two-shot moulding; and
gluing the electronic components onto the direct contacts using a conductive glue.

14. The method of claim 8, wherein the electronic components comprise at least one of: a processor, a digital signal processor, at least one light detector, at least one light emitter, at least one sensor, at least one microphone, at least one power supply, at least one transducer that is to be employed to generate vibrations.
